(19) United States
(12) Patent Application Publication
(10) Pub. No.: US 2009/0283714 A1
(43) Pub. Date: Nov. 19, 2009

(54) ETCHING GAS FOR REMOVING ORGANIC LAYERS

(76) Inventor: Chung-Chih Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/120,235

(22) Filed: May 14, 2008

(51) Int. Cl. C09K 13/00

(52) U.S. Cl. 252/79.1

(57) ABSTRACT

An etching gas for removing organic layer is disclosed. The etching gas of the present invention preferably includes two compositions. The first composition of the etching gas includes hydrocarbon, halogen or halogen compound, oxygen gas, hydrogen gas, nitrogen has, and inert gas, in which the hydrocarbon comprises an alkene. The second composition of the etching gas includes hydrocarbon, halogen or halogen compound, oxygen gas, hydrogen gas, nitrogen gas, and inert gas, in which the hydrocarbon comprises an alkyne. The etching gas of the present invention may also include hydrofluorocarbon compounds, hydrogen chloride, and hydrogen bromide to improve the performance of the etching process.

### BACKGROUND OF THE INVENTION

1. Field of the Invention

The invention relates to an etching gas, and more particularly, to an etching gas for removing organic layers.

2. Description of the Prior Art

Lithography and etching are the most important steps in semiconductor fabrication in forming vias, metal interconnects and other devices. Conventional single-layer resist is applied on sub-quarter-micron line widths on planar, non-reflective silicon substrate of semiconductor wafer. When conventional single-layer resists is applied over a reflective topography, thickness variations in the resist layer result in poor line width control, whereas reflections of topographic sidewalls can cause “notching” effects.

As the semiconductor devices evolve toward the direction of small size and high integration, multilayer photoresists are gradually used to replace single-layer photoresists for improving the resolution of lithography. A conventional multilayer photoresist, such as a double-layer photoresist is composed of an antireflective bottom resist disposed on a wafer or silicon substrate, and a top resist or imaging layer disposed on the bottom resist. The bottom resist is preferably a planarizing layer or an antireflective layer composed of organic polymers. After a lithography and etching process is performed to pattern the top resist, the patterned top resist is used as a mask for etching the bottom resist. As the bottom resist is composed of organic polymers, a plasma etching process is typically used to etch the bottom resist. Accordingly, a photoresist pattern having high aspect ratio is produced in the double-layer photoresist.

Referring to FIGS. 1-3, FIGS. 1-3 illustrate a method for patterning a double-layer photoresist according to the prior art. As shown in FIG. 1, a semiconductor substrate 5 is provided, and a thin film 4 and a double-layer mask 6 comprised of an antireflective layer 7 and a photosensitive layer 3 are deposited on the semiconductor substrate 5. Preferably, the antireflective layer 7 is composed of organic antireflective material. A photolithography process is then performed by using a photomask (not shown) to pattern the photosensitive layer 3 by forming an opening 2 in the patterned photosensitive layer 3.

As shown in FIGS. 2-3, a plasma etching process is conducted by using the patterned photosensitive layer 3 as mask to remove a portion of the antireflective layer 7 and the thin film 4. The plasma etching preferably transfers the pattern of the opening 2 to the antireflective layer 7 and the thin film 4 and forms a corresponding opening 2 in the antireflective layer 7 and the thin film 4.

It should be noted that the conventional plasma etching process typically uses an etching gas consisting of oxygen gas, nitrogen gas, hydrogen gas, inert gases, and halogen or halogen compound to etch organic layers such as the antireflective layer 7. This etching gas composition however does not have a well controlled anisotropic property, and as a result, a lateral etching phenomenon is readily observed in the antireflective layer 7 and the thin film 4, which further causes poor control over the critical dimension of the device.

Moreover, as the integration of the fabrication increases and the size of the device or the gap between openings decreases, problems including the reactant or ions contained in the etching gas being unable to reach to the bottom of the etched opening or reacting by-product being unable to pass out from the vias also arise and significantly lower the rate of the etching process. As this phenomenon worsens as the size of the device decreases, a micro-loading effect would result.

### SUMMARY OF THE INVENTION

It is an objective of the present invention to provide an etching gas for solving the aforementioned problems.

An etching gas having two primary composition is disclosed. The first composition of the etching gas includes hydrocarbon, halogen or halogen compound, and oxygen gas, in which the hydrocarbon comprises an alkene. The second composition of the etching gas includes hydrocarbon, halogen or halogen compound, and oxygen gas, in which the hydrocarbon comprises an alkyne. The halogen compound of the etching gas is selected from the group consisting of hydrofluorocarbon compounds including CF₄, C₂F₆, C₄F₆, C₄F₈, C₅F₈, CHF₃, CH₂F₂, and CH₃F, hydrogen chloride, and hydrogen bromide, and other reacting gas such as hydrogen gas, nitrogen gas, inert gases, or alkanes may also be added to the above two gas compositions to improve the overall performance of the etching process.

The present invention specifically uses the alkene hydrocarbon or alkyne hydrocarbon content of the etching gas to provide carbon linkages for the formation of polymers during the etching process, in which the carbon linkages would interact with halogen atoms to form rigid bonds for creating small quantity but strong accumulation of polymers. The accumulation of these polymers not only improves the control over the critical dimension of the device, but also reduces the impact caused by micro-loading effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 illustrate a method for patterning a double-layer photoresist according to the prior art.

FIGS. 4-6 illustrate a method of patterning a double-layer photoresist according to a first embodiment of the present invention.

FIGS. 7-8 illustrate a method of patterning a tri-layer photoresist according to a second embodiment of the present invention.

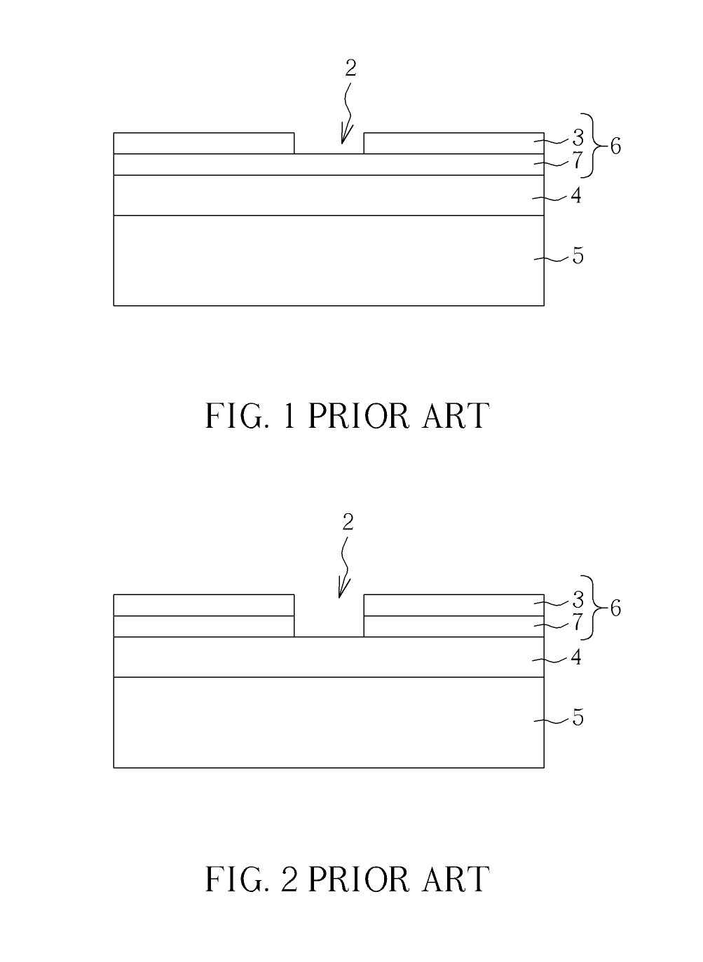

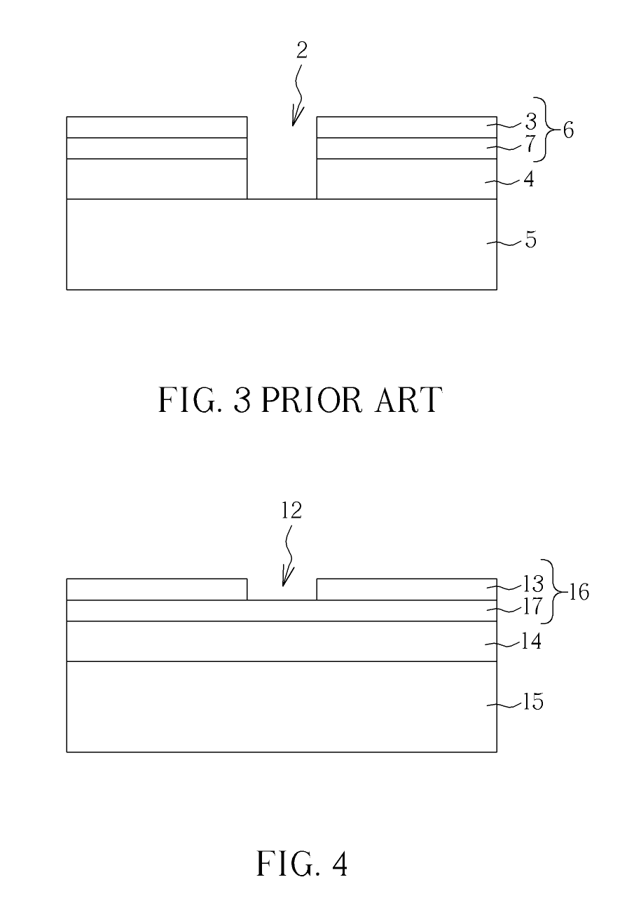

### DETAILED DESCRIPTION

The present invention discloses an etching gas for etching organic layers, in which the etching gas includes two primary compositions. The first composition of the etching gas includes hydrocarbon, halogen or halogen compound, and oxygen gas, in which the hydrocarbon comprises an alkene. The second composition of the etching gas includes hydrocarbon, halogen or halogen compound, and oxygen gas, in which the hydrocarbon comprises an alkyne. Preferably, either one of the two compositions could be used to etch any organic layer, such as a double-layer photoresist containing a deep UV photoresist and an antireflective layer composed of organic polymers or a tri-layer structure composed of a deep UV photoresist, a silicon-containing hard mask (SHB) and a ultraviolet photoresist.

Referring to FIGS. 4-6, FIGS. 4-6 illustrate a method of using the aforementioned etching gas to pattern a double-layer photoresist according to a first embodiment of the present invention. As shown in FIG. 4, a semiconductor substrate 15 is provided, and a thin film 14 and a double-layer mask 16 having an antireflective layer 17 and a photosensitive layer 13 are deposited on the semiconductor substrate 15. Preferably, the antireflective layer 17 is composed of organic antireflective material. A photolithography process then performed by using a photomask (not shown) to pattern the photosensitive layer 13 by forming an opening 12 in the patterned photosensitive layer 13.

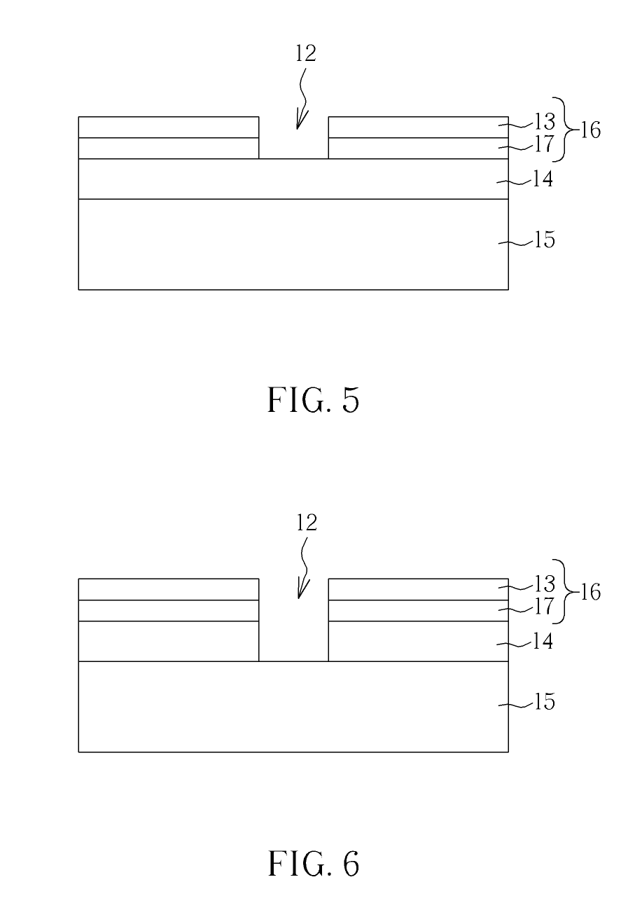

As shown in FIG. 5, a plasma etching process is conducted by using the patterned photosensitive layer 13 as mask to form an opening 12 in the antireflective layer 17 and the thin film 14. According to the preferred embodiment of the present invention, the etching gas used during the plasma etching process is selected from either one of aforementioned compositions. For instance, the present invention could use the first etching gas containing alkene hydrocarbon, halogen or halogen compound, and oxygen gas, or the second etching gas containing alkyne hydrocarbon, halogen or halogen compound, and oxygen gas to etch the antireflective layer 17 and the thin film 14. The halogen compound contained within the etching gas is selected from the group consisting of hydrofluorocarbon compounds including CF₄, C₂F₆, C₄F₆, C₄F₈, C₅F₈, CHF₃, CH₂F₂, and CH₃F, hydrogen chloride, and hydrogen bromide.

In addition to the aforementioned gas compositions, other gases including hydrogen gas, nitrogen gas, inert gases and alkanes could also be added into the first etching gas or the second etching gas to improve the efficiency and balance of the etching process. For instance, the inert gas is preferably used as a carrier gas during the etching process, in which the utilization of nitrogen gas not only facilitates the heat distribution of the process, but also eliminates the chance for reacting with the organic layer underneath. According to the preferred embodiment of the present invention, the inert gas used during the etching process is preferably helium gas, in which the helium gas could be utilized to significantly improve the iso-dense loading effect caused during the etching process.

According to another embodiment of the present invention, different hydrocarbon content could be added to the first etching gas or the second etching gas while the etching process is conducted. For instance, the present invention could add an alkyne hydrocarbon to the first etching gas, or add an alkene hydrocarbon to the second etching gas to form another etching gas composition, which are all within the scope of the present invention.

It should be noted that the alkene hydrocarbon and the alkyne hydrocarbon have the characteristic of generating chemical bonds and by using these two hydrocarbons to generate and accumulate enough polymers on the sidewall of the etched opening, the present invention not only improves the control over the critical dimension of the device, but also reduces the impact caused by micro-loading effect.

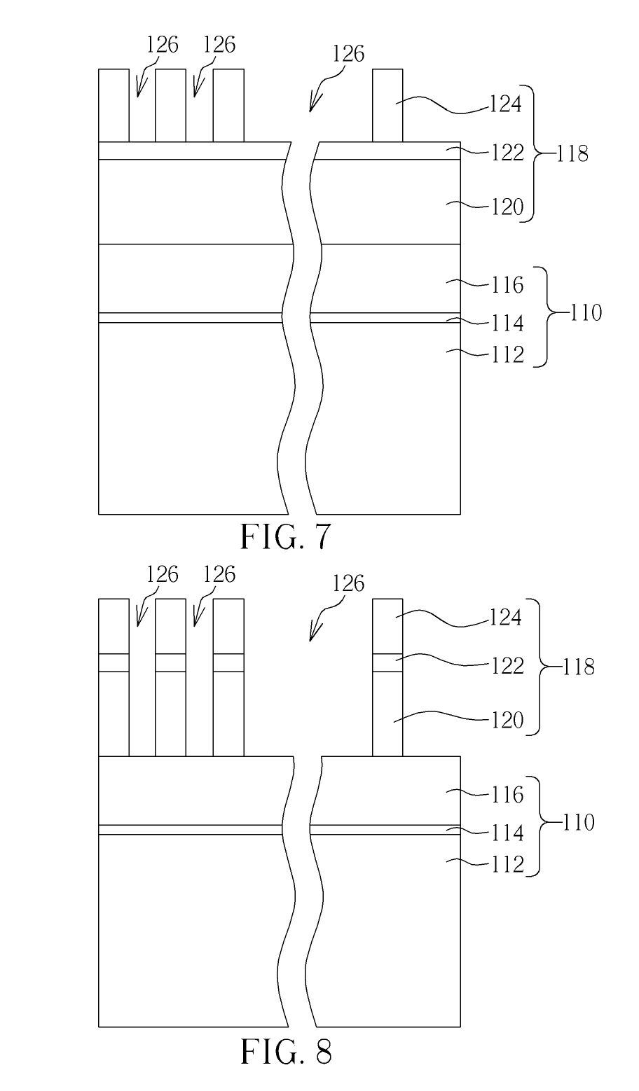

In addition to the double-layer photoresist structure, the etching gas of the present invention could also be applied to other etching target, such as a tri-layer photoresist. Referring to FIGS. 7-8, FIGS. 7-8 illustrate a method of patterning a tri-layer photoresist according to a second embodiment of the present invention. It is to be understood that the drawings are not drawn to scale and are served only for illustration purposes. As shown in FIG. 7, a substrate 110 is provided. The substrate 110 includes a silicon layer 112, a pad oxide layer 114, and a silicon nitride layer 116. The silicon layer 112 can be a target layer for patterning, the silicon nitride layer 116 can be a hard mask (HD) during the etching process, and the pad oxide layer 114 can be a buffer layer or a glue layer between the silicon layer 112 and the silicon nitride layer 116. In other embodiments, the silicon layer 112, the pad oxide layer 114, and the silicon nitride layer 116 can be replaced by other material layers, and the silicon layer 112 can include silicon-containing materials, low dielectric constant (low-k) materials, oxide-containing materials, polysilicon, silicon nitride compounds (SiₓN_{y}), silicon carbide (SiC), silicon carbon compounds (SiₓC_{y}), titanium nitride (TiN), strained silicon, strained silicon-on-insulator, or any combination thereof.

A multi-layer stacked structure, such as a tri-layer structure 118, is substantially formed on the silicon nitride layer 116. The tri-layer structure 118 is primarily composed of a photoresist 120, a silicon-containing hard mask (SHB) 122, and a photoresist 124. In this embodiment, the photoresist 120, which may improve adhesion and provide a function of anti-reflection, can include 365 nm (I-line) or novolac resin (I-line like), in which the photoresist 120 is preferably used as a mask for the pattern transfer process. The silicon-containing hard mask 122 can include silicon-containing polymers and has a function of anti-erosion. The photoresist 124 can be a 193 nm or 248 nm deep ultraviolet photoresist, which may be used to improve the resolution of the tri-layer structure 118.

A pattern transfer process is then performed by using a photomask (not shown) to conduct an exposure and developing process for forming a plurality of openings 126 in the photoresist 124. As shown in FIG. 8, a plasma etching process is performed thereafter by using the patterned photoresist 124 as a mask to form a plurality of corresponding openings 126 in the silicon-containing hard mask 122 and the photoresist 120.

Similar to the aforementioned embodiment, the etching gas used during the plasma etching process is selected from either one of aforementioned etching gas compositions. For instance, the present invention could use the first etching gas containing alkene hydrocarbon, halogen or halogen compound, and oxygen gas, or the second etching gas containing alkyne hydrocarbon, halogen or halogen compound, and oxygen gas to etch the silicon-containing hard mask 122 and the photoresist 120. The halogen compound contained within the etching gas is selected from the group consisting of hydrofluorocarbon compounds including CF₄, C₂F₆, C₄F₆, C₄F₈, C₅F₈, CHF₃, CH₂F₂, and CH₃F, hydrogen chloride, and hydrogen bromide. Moreover, the present invention could add other reacting gas, such as hydrogen gas, nitrogen gas, inert gases and alkanes into the first etching gas or the second etching gas to improve the efficiency and balance of the etching process.

Overall, the present invention uses the alkene hydrocarbon or alkyne hydrocarbon content of the etching gas to provide carbon linkages for the formation of polymers during the etching process, in which the carbon linkages would interact with halogen atoms to form rigid bonds for creating small quantity but strong accumulation of polymers. The accumulation of these polymers not only improves the control over the critical dimension of the device, but also reduces the impact caused by micro-loading effect.

Those skilled in the art will readily observe that numerous modifications and alterations of the device and method may be made while retaining the teachings of the invention.

What is claimed is:

1. An etching gas for removing organic layers, comprising hydrocarbon, halogen or halogen compound, and oxygen gas, wherein the hydrocarbon comprises an alkene.

2. The etching gas for removing organic layers of claim 1, further comprising an alkyne.

3. The etching gas for removing organic layers of claim 1, wherein the halogen compound is selected from the group consisting of hydrofluorocarbon compounds including CF₄, C₂F₆, C₄F₆, C₄F₈, C₅F₈, CHF₃, CH₂F₂, and CH₃F, hydrogen chloride, and hydrogen bromide.

4. The etching gas for removing organic layers of claim 1, further comprising hydrogen gas.

5. The etching gas for removing organic layers of claim 1, further comprising nitrogen gas.

6. The etching gas for removing organic layers of claim 1, further comprising an inert gas.

7. The etching gas for removing organic layers of claim 1, wherein the hydrocarbon comprises an alkane.

8. An etching gas for removing organic layers, comprising hydrocarbon, halogen or halogen compound, and oxygen gas, wherein the hydrocarbon comprise an alkyne.

9. The etching gas for removing organic layers of claim 8, further comprising an alkene.

10. The etching gas for removing organic layers of claim 8, wherein the halogen is selected from the group consisting of hydrofluorocarbon compounds including CF₄, C₂F₆, C₄F₆, C₄F₈, C₅F₈, CHF₃, CH₂F₂, and CH₃F, hydrogen chloride, and hydrogen bromide.

11. The etching gas for removing organic layers of claim 8, further comprising hydrogen gas.

12. The etching gas for removing organic layers of claim 8, further comprising nitrogen gas.

13. The etching gas for removing organic layers of claim 8, further comprising an inert gas.

14. The etching gas for removing organic layers of claim 8, wherein the hydrocarbon comprises an alkane.
